(19) United States
(12) Patent Application Publication
(10) Pub. No.: US 2022/0158316 A1
(43) Pub. Date: May 19, 2022

(54) FILTER AND METHOD OF MANUFACTURING FILTER

(71) Applicant: FUJIKURA LTD., Tokyo (JP)

(72) Inventor: Yusuke Uemichi, Sakura-shi (JP)

(73) Assignee: FUJIKURA LTD., Tokyo (JP)

(21) Appl. No.: 17/428,174

(22) PCT Filed: Mar. 6, 2020
(86) PCT No.: PCT/JP2020/009551

§ 371 Date: Aug. 3, 2021

(30) Foreign Application Priority Data
Mar. 14, 2019 (JP) 2019-047552

(51) Int. Cl. H01P 1/207; H01P 3/12; H01P 11/00

(52) U.S. Cl. CPC H01P 1/207; H01P 11/002; H01P 3/121

(57) ABSTRACT

A filter that makes it easy to adjust a center frequency of a passband is implemented. The filter (1) includes a post-wall waveguide (11) functioning as a plurality of resonators (11a to 11e) that are electromagnetically coupled to each other and cavities (12a to 12e) stacked on the post-wall waveguide (11). The cavities (12a to 12e) are electromagnetically coupled with resonators (11a to 11e) via coupling windows (112a to 112e) formed in a broad wall (first broad wall (112)) of the post-wall waveguide (11).

### TECHNICAL FIELD

The present invention relates to a filter using a post-wall waveguide. The present invention also relates to a method of manufacturing this filter.

### BACKGROUND ART

It is known that a plurality of resonators that are electromagnetically coupled to each other function as a band-pass filter that selectively allows electromagnetic waves of a specific frequency band (hereinafter, also referred to as “passband”) to pass.

For example, in Patent Document 1, it is described that a band-pass filter is implemented by forming a plurality of resonators inside a waveguide tube. In the band-pass filter described in Patent Document 1, a screw is inserted into the resonator, and the center frequency of the passband can be adjusted by changing the insertion amount of the screw.

Also, instead of a waveguide tube, it is known that a post-wall waveguide functions as a waveguide. The post-wall waveguide includes a dielectric substrate, broad walls covering the two main surfaces of the dielectric substrate, respectively, and a post-wall formed inside the dielectric substrate, with the region enclosed by the broad walls and the post-wall forming a waveguide through which electromagnetic waves travel. Compared to waveguide tubes, post-wall waveguides have the advantage that weight reduction, height reduction, and cost reduction are easily achieved. In Non-patent Document 1, it is described that a band-pass filter is implemented by forming a plurality of resonators inside a post-wall waveguide.

### CITATION LIST

### Patent Literature

Patent Document 1: JP H8-162805 A

### Non-Patent Literature

Non-patent Document 1: Yusuke Uemichi, et. al, Compact and Low-Loss Bandpass Filter Realized in Silica-Based Post-Wall Waveguide for 60-GHz applications, IEEE MTT-S IMS, May 2015.

### SUMMARY OF INVENTION

### Technical Problem

However, a filter using a post-wall waveguide has had problems in that the center frequency of the passband is difficult to adjust. For example, the center frequency of the passband cannot be adjusted by applying the technique described in Patent Document 1 to a filter using a post-wall waveguide. This is because, when a screw is inserted into a post-wall waveguide, there is a high likelihood of damage being caused to the dielectric substrate (made of quartz glass, for example).

In light of the problem described above, an object of an aspect of the present invention is to implement a filter using a post-wall waveguide that makes it easy to adjust a center frequency of a passband.

### Solution to Problem

A filter according to an aspect of the present invention employs a configuration including:

a post-wall waveguide functioning as a resonator group including a plurality of resonators that are electromagnetically coupled to each other; and

at least one cavity stacked on the post-wall waveguide, wherein

the cavity is electromagnetically coupled with a resonator of the resonator group via a coupling window formed in a broad wall of the post-wall waveguide.

### Advantageous Effects of Invention

According to an aspect of the present invention, a filter that makes it easy to adjuct a center frequency of a passband can be implemented.

### BRIEF DESCRIPTION OF DRAWINGS

FIG. 1 is an exploded perspective view illustrating the configuration of a filter according to a first embodiment of the present invention.

FIG. 2 is a partial cross-sectional view of the filter illustrated in FIG. 1.

FIG. 3 is a plan view of a post-wall waveguide provided in the filter illustrated in FIG. 1.

FIG. 4 is a graph showing the frequency characteristics of a transmission coefficient S(2,1) and reflection characteristics (1,1) of the filter illustrated in FIG. 1. In FIG. 4(a), the height of each of the cavities is set to 25 μm, 50 μm, 100 μm, and 300 μm. In FIG. 4(b), the height of each of the cavities is set to 100 μm, 300 μm, and 600 μm.

FIG. 5 is a graph showing the electric field distribution in the filter illustrated in FIG. 1. FIG. 5(a) shows a case where the height of the cavities is less than the radius of the cavities, FIG. 5(b) shows a case where the height of the cavities is equal to the radius of the cavities, and FIG. 5(c) shows a case where the height of the cavities is greater than the radius of the cavities.

FIG. 6 is an exploded perspective view illustrating the configuration of a filter according to a second embodiment of the present invention.

FIG. 7 is a partial cross-sectional view of the filter illustrated in FIG. 6.

FIG. 8(a) is a graph showing the transmission coefficient of the filter illustrated in FIG. 6, and FIG. 8(b) is a graph showing the reflection coefficient of the filter illustrated in FIG. 6. Here, the radius of each of the cavities is changed from 200 μm to 600 μm in steps of 50 μm.

FIG. 9 is a graph showing the electric field distribution in the cavity of the filter illustrated in FIG. 6.

FIG. 10(a) is a graph showing the frequency characteristics of the transmission coefficient S(2,1) of a filter (comparative example) in which the cavities are omitted from the filter illustrated in FIG. 1. FIG. 10(b) is a graph showing the frequency characteristics of the transmission coefficient S(2,1) of the filter (example) illustrated in FIG. 1.

### DESCRIPTION OF EMBODIMENTS

### First Embodiment

### Filter Structure

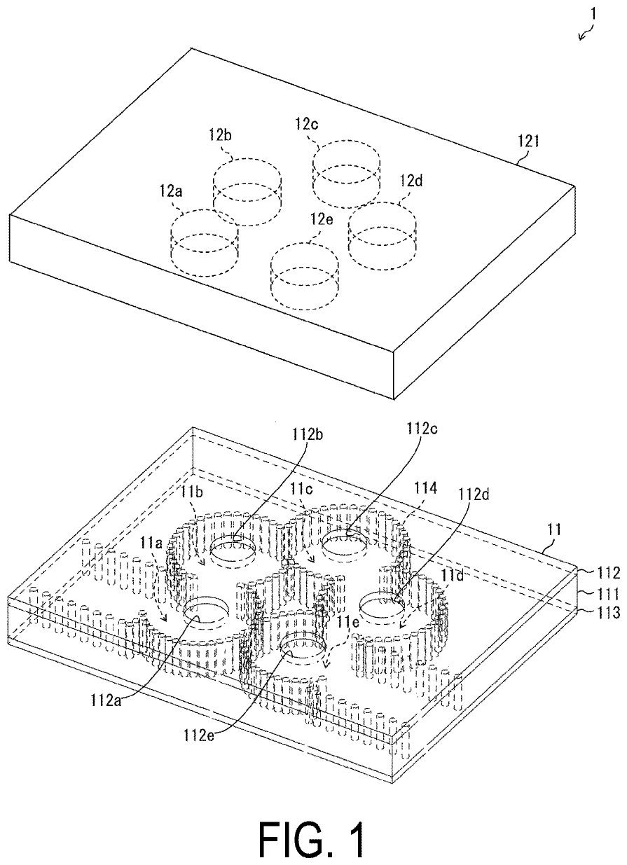

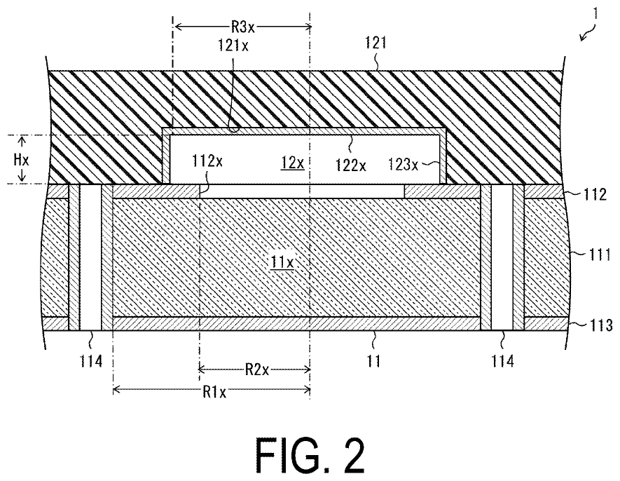

The structure of a filter 1 according to the first embodiment of the present invention will be described with reference to FIGS. 1 and 2. FIG. 1 is an exploded perspective view of the filter 1, and FIG. 2 is a partial cross-sectional view of the filter 1.

The filter 1 includes a post-wall waveguide 11 functioning as a plurality of resonators 11a to 11e that are electromagnetically coupled to each other and cavities 12a to 12e stacked on the post-wall waveguide 11, the cavities 12a to 12e numbering the same as the resonators 11a to 11e.

The post-wall waveguide 11 includes a dielectric substrate 111, a first broad wall 112 formed on a first main surface (the upper surface in FIGS. 1 and 2) of the dielectric substrate 111, a second broad wall 113 formed on a second main surface (the lower surface in FIGS. 1 and 2) of the dielectric substrate 111, and a post-wall 114 formed inside the dielectric substrate 111.

The dielectric substrate 111 is a plate-like member formed from a dielectric material. In the present embodiment, quartz glass is used as the dielectric material forming the dielectric substrate 111. In this case, the thickness of the dielectric substrate 111 may be 500 μm, for example.

The first broad wall 112 and the second broad wall 113 are layer-like (or film-like) members formed from a conductor material. In the present embodiment, copper is used as the conductor material forming the first broad wall 112 and the second broad wall 113.

The post-wall 114 is an assembly of conductor posts arranged side by side in a fence-like manner and forming a short circuit between the first broad wall 112 and the second broad wall 113. The spacing of the conductor posts forming the post-wall 114 is sufficiently small compared to the wavelength of the electromagnetic waves input into the post-wall waveguide 11, and the post-wall 114 functions as a conductor wall for the electromagnetic waves. The diameter of the conductor posts can be, for example, 100 μm, and the spacing of the conductor posts can be, for example, 200 μm. In the present embodiment, each of the conductor posts forming the post-wall 114 is implemented by forming a conductor layer on the inner wall of the through-hole that extends through the dielectric substrate 111 or filling the through-hole with a conductor. The arrangement pattern of the post-wall 114 is set such that the area enclosed by the first broad wall 112, the second broad wall 113, and the post-wall 114 functions as a plurality of resonators 11a to 11e that are electromagnetically coupled to each other. The arrangement pattern of the post-wall 114 is described later with reference to another drawing.

Coupling windows 112a to 112e numbering the same as the resonators 11a to 11e are formed in the first broad wall 112 of the post-wall waveguide 11. Each of the resonators 11x (x=a, b, c, d, e) is electromagnetically coupled with a corresponding cavity 12x via a corresponding coupling window 112x. To increase the coupling efficiency between the resonator 11x and the cavity 12x, each of the coupling windows 112x is formed overlapping the center of the corresponding resonator 11x in a plan view of the first broad wall 112. In the present embodiment, each of the resonators 11x has a cylindrical shape with a height direction corresponding to the direction orthogonal to the first broad wall 112, and each of the coupling windows 112x has a circular shape. A radius R1x of a cross-section (cross-section parallel with the main surface of the dielectric substrate 111) of each of the resonators 11x (hereinafter, shortened to radius R1x of the resonator 11x) and a radius R2x of the corresponding coupling window 112x have the relationship R2x<R1x.

Each of the cavities 12x is a space enclosed by a conductor. In the present embodiment, each of the cavities 12x is implemented via a plate-like member 121, a broad wall 122x, and a narrow wall 123x.

The plate-like member 121 is a plate-like member formed from a discretionary material (which may be a conductor material such as a metal or a dielectric material such as a resin). A recess portion 121x is formed in the second main surface (the lower surface in FIGS. 1 and 2) of the plate-like member 121. The depth of the recess portion 121x (corresponding to the sum of the height of the cavity 12x and the thickness of the broad wall 122x) is adjusted so that the center frequency of the passband of the filter 1 is a desired value, as described below.

Each of the broad wall 122x and the narrow wall 123x is a layer-like (or film-like) member formed from a conductor material. The broad wall 122x is formed on the bottom surface of the recess portion 121x, and the narrow wall 123x is formed on a side surface of the recess portion 121x. In the present embodiment, copper is used as the conductor material forming the broad wall 122x and the narrow wall 123x. The broad wall 122x and the narrow wall 123x may be implemented using a single conductor layer. Also, the broad wall 122x and the narrow wall 123x may be implemented by forming a conductor layer on the entire second main surface of the plate-like member 121, without being limited to the inside or the outside of the recess portion 121x. This allows each of the cavities 12x to be easily manufactured. Also, in a case where the plate-like member 121 is formed from a conductor material, the bottom surface of the recess portion 121x of the plate-like member 121 functions as the broad wall 122x, and the side surface of the recess portion 121x of the plate-like member 121 functions as the narrow wall 123x.

The plate-like member 121 is stacked on the post-wall waveguide 11 such that the second main surface side comes into contact with the first broad wall 112 of the post-wall waveguide 11 and the recess portion 121x communicates with the resonator 11x via the coupling window 112x. In this manner, the recess portion 121x enclosed by the broad wall 122x and the narrow wall 123x and filled with a dielectric such as air functions as the cavity 12x. The cavity 12x is electromagnetically coupled with the corresponding resonator 11x via the corresponding coupling window 112x. In the present embodiment, each of the cavities 12x has a cylindrical shape with a height direction corresponding to the direction orthogonal to the first broad wall 112. A radius R3x of the bottom surface of each of the cavities 12x (hereinafter, shortened to radius R3x of the cavity 12x) and the radius R1x of the corresponding resonator 11x have the relationship R3x<R1x, and the radius R3x of each of the cavities 12x and the radius R2x of the corresponding coupling window 112x have the relationship R2x<R3x.

Note that in the present embodiment, quartz glass is used as the dielectric material forming the dielectric substrate 111 of the post-wall waveguide 11. However, the present invention is not limited to this. The dielectric material forming the dielectric substrate 111 of the post-wall waveguide 11 may be a dielectric material other than quartz, such as sapphire, alumina, or the like, for example.

Also, in the present embodiment, copper is used as the conductor material forming the first broad wall 112 and the second broad wall 113 of the post-wall waveguide 11. However, the present invention is not limited to this. The conductor material forming the first broad wall 112 and the second broad wall 113 of the post-wall waveguide 11 may be a conductor material other than copper, such as aluminum or an alloy formed from a plurality of metal elements, for example.

Also, in the present embodiment, each of the resonators 11x has a cylindrical shape. However, the present invention is not limited to this. Each of the resonators 11x may have, for example, a prismatic shape in which the cross-section (the cross-section parallel with the main surface of the dielectric substrate 111) is a regular polygon having six or more sides.

Also, in the present embodiment, each of the coupling windows 112x has a circular shape. However, the present invention is not limited to this. Each of the coupling windows 112x may have, for example, a regular polygon shape having six or more sides.

Also, in the present embodiment, each of the cavities 12x, which is a hollow, is filled with air. However, the present invention is not limited to this. Each of the cavities 12x may be filled with a dielectric other than air, such as a resin or the like, for example.

Also, in the present embodiment, each of the cavities 12x has a cylindrical shape. However, the present invention is not limited to this. Each of the cavities 12x may have, for example, a prismatic shape in which the bottom surface has a regular polygon shape having six or more sides.

Also, in the present embodiment, copper is used as the conductor material forming the broad wall 122x and the narrow wall 123x of each of the cavities 12x. However, the present invention is not limited to this. The conductor material forming the broad wall 122x and the narrow wall 123x of each of the cavities 12x may be aluminum or an alloy formed from a plurality of metal elements, for example.

Also, in the present embodiment, the coupling windows 112a to 112e and the cavities 12a to 12e are formed on the first broad wall 112 side. However, the present invention is not limited to this. In other words, the coupling windows 112a to 112e and the cavities 12a to 12e may be formed on the second broad wall 113 side, or may be split and formed on the first broad wall 112 side and on the second broad wall 113 side. For example, a configuration in which the coupling windows 112a, 112c, 112e and the cavities 12a, 12c, 12e are formed on the first broad wall 112 side, and the coupling windows 112b, 112d and the cavities 12b, 12d are formed on the second broad wall 113 side is also included within the scope of the present invention.

Also, in the present embodiment, the resonators 11a to 11e, the coupling windows 112a to 112e, and the cavities 12a to 12e each number five. However, the present invention is not limited to this. In other words, the resonators 11a to 11e, the coupling windows 112a to 112e, and the cavities 12a to 12e may each number a discretionary number of two or more.

### Post-Wall Arrangement Pattern

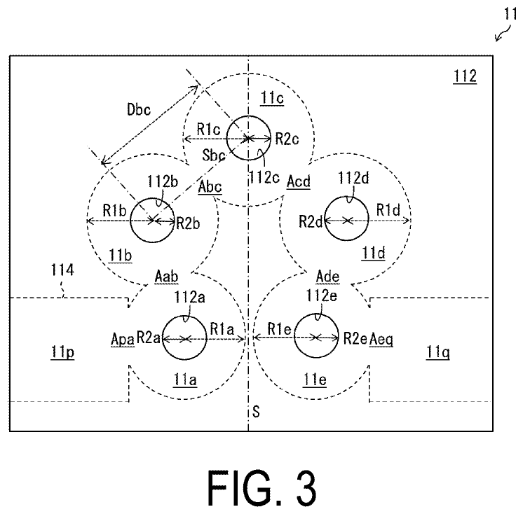

The arrangement pattern of the post-wall 114 in the post-wall waveguide 11 will be described with reference to FIG. 3. FIG. 3 is a plan view of the post-wall waveguide 11. Note that in FIG. 3, the post-wall 114 is illustrated by a broken line as a virtual conductor wall.

The arrangement pattern of the post-wall 114 is set such that the region enclosed by the first broad wall 112, the second broad wall 113, and the post-wall 114 includes the following configurations.
An input waveguide 11p
The resonator 11a electromagnetically coupled with the input waveguide 11p via a coupling window Apa
The resonator 11b electromagnetically coupled with the resonator 11a via a coupling window Aab
The resonator 11c electromagnetically coupled with the resonator 11b via a coupling window Abc
The resonator 11d electromagnetically coupled with the resonator 11c via a coupling window Acd
The resonator 11e electromagnetically coupled with the resonator 11d via a coupling window Ade
An output waveguide 11q electromagnetically coupled with the resonator 11e via a coupling window Aeq

The resonators 11a to 11e have a cylindrical shape, and the input waveguide 11p and the output waveguide 11q have a rectangular parallelepiped shape. The center-to-center distance between two resonators adjacent to each other (for example, the resonator 11b and the resonator 11c) is less than the sum of the radii of these two resonators. For example, a center-to-center distance Dbc of two resonators 11b, 11c adjacent to each other is set satisfying the relationship Dbc<R1b+R1c. Accordingly, two resonators adjacent to each other are electromagnetically coupled via the coupling window. For example, two resonators 11b, 11c adjacent to each other are electromagnetically coupled via the coupling window Abc.

The two resonators adjacent to each other are symmetrical with respect to a plane that includes the center axis of the two resonators. For example, the two resonators 11b, 11c adjacent to each other are symmetrical with respect to a plane Sbc (see FIG. 3) that includes the center axis of the two resonators 11b, 11c. Also, the resonator group including the resonators 11a to 11 e is symmetric with respect to a specific plane S (see FIG. 3) orthogonal to the first broad wall 112. By giving the post-wall 114 this symmetry and reducing the number of independent parameters for specifying the arrangement pattern of the post-wall 114, the filter 1 can be easily designed.

Also, the resonator 11a coupled with the input waveguide 11p and the resonator 11e coupled with the output waveguide 11q are arranged adjacent to each other, and the entire resonators 11a to 11e are arranged in an annular shape. In this manner, the size of the dielectric substrate 111 in which the post-wall 114 is formed can be reduced. This can reduce the absolute value of thermal expansion or thermal shrinkage of the dielectric substrate 111 that may occur when the environmental temperature changes. Thus, characteristic changes in the filter 1 that may occur due to thermal expansion or thermal shrinkage of the dielectric substrate 111 can be suppressed when the environmental temperature changes.

Note that herein, the waveguide coupled with the resonator 11a is referred to as the input waveguide 11p, and the waveguide coupled with the resonator 11e is referred to as the output waveguide 11q. However, no such limitation is intended. The waveguide coupled with the resonator 11a may be an output waveguide, and the waveguide coupled with the resonator 11e may be an input waveguide.

### Cavity Function

The filter 1 includes the post-wall waveguide 11 functioning as the plurality of resonators 11a to 11e that are electromagnetically coupled to each other. Accordingly, the filter 1 functions as a band-pass filter that selectively allows electromagnetic waves of a specific frequency band (hereinafter “passband”) to pass. The cavities 12a to 12e are used to adjust the center frequency of this passband.

The results of an electromagnetic field simulation conducted to investigate the transmission characteristics and reflection characteristics of the filter 1 will be described below. Note that in an electromagnetic field simulation, it is assumed that the material of the dielectric substrate 111 is set as quartz, the thickness of the dielectric substrate 111 is set as 520 μm, the radii R1a, R1e of the resonators 11a, 11 e are set as 800 μm, the radii R1b to R1d of the resonators 11b to 11d are set as 840 μm, the radius R2x of each of the coupling windows 112x is set as 300 μm, the dielectric filling each of the cavities 12x is set as air, and the radius R3x of each of the cavities 12x is set as 300 μm.

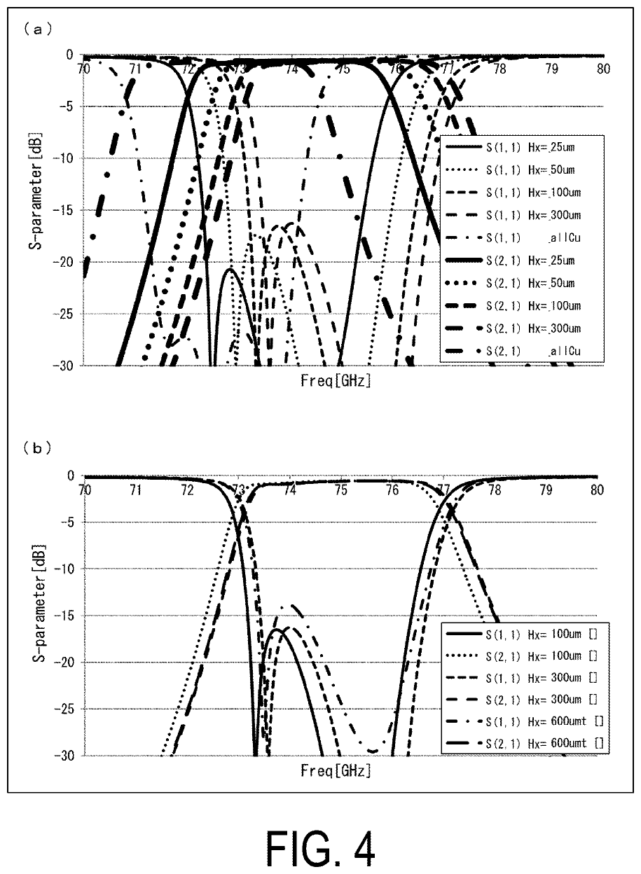

FIG. 4(a) is a graph showing the frequency characteristics of the transmission coefficient S(2,1) and the reflection coefficient S(1,1) of the filter 1, with a height Hx of each of the cavities 12x being uniformly set to 25 μm, 50 μm, 100 μm, and 300 μm.

The following can be seen from the graph of the transmission coefficient S(2,1) shown in FIG. 4(a).
In a case where the height Hx of each of the cavities 12x is equal to or less than the radius R3x of the cavities 12x, the higher the height H of the cavities 12x, the more the center frequency of the passband shifts to the high frequency side.

The following can be seen from the graph of the reflection coefficient S(1,1) shown in FIG. 4(a).
In a case where the height Hx of each of the cavities 12x is equal to or less than the radius R3x of the cavities 12x, the reflection coefficient S(1,1) in the passband is suppressed to at most −15 dB.

FIG. 4(b) is a graph showing the frequency characteristics of the transmission coefficient S(2,1) and the reflection coefficient S(1,1) of the filter 1, with a height Hx of each of the cavities 12x being uniformly set to 100 μm, 300 μm, and 600 μm.

The following can be seen from the graph of the transmission coefficient S(2,1) shown in FIG. 4(b).
In a case where the height Hx of cavities 12x is equal to or less than the radius R3x of the cavities 12x, the center frequency of the passband strongly depends on (is sensitive toward) the height Hx of the cavities 12x. In this case, the higher the height Hx of the cavities 12x, the more the center frequency of the passband shifts to the high frequency side.
In a case where the height Hx of cavities 12x is equal to or greater than the radius R3x of the cavities 12x, the center frequency of the passband does not strongly depend on (is not sensitive toward) the height Hx of the cavities 12x. In this case, the higher the height Hx of the cavities 12x, the more the center frequency of the passband shifts to the low frequency side.

The following can be seen from the graph of the reflection coefficient S(1,1) shown in FIG. 4(b).
In a case where the height Hx of the cavities 12x is equal to or less than 600 μm, the reflection coefficient S(1,1) in the passband is suppressed to at most −13 dB.

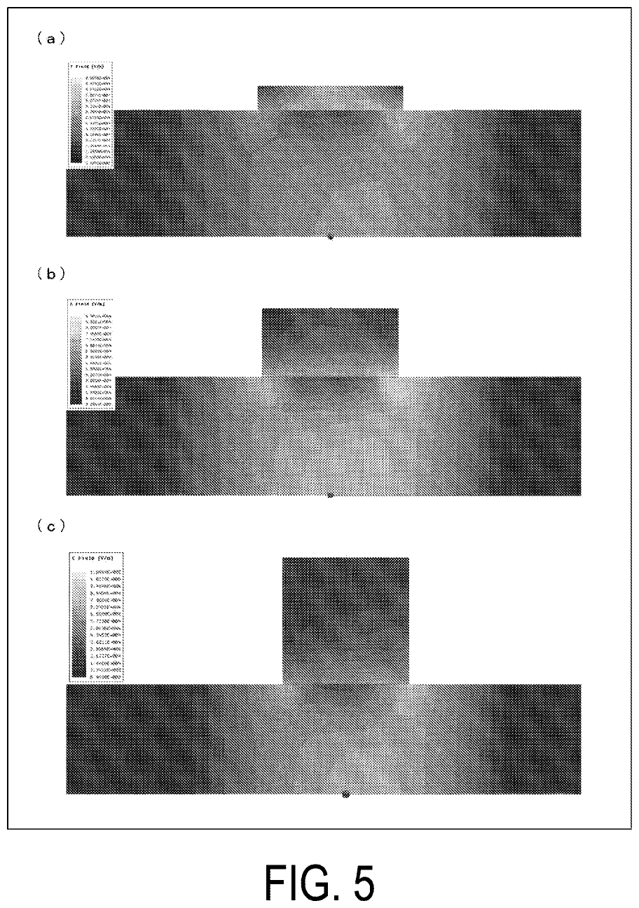

FIG. 5(a) is a graph showing the electric field distribution within the filter 1 obtained with the height Hx of the cavities 12x being less than the radius R3x of the cavities 12x. FIG. 5(b) is a graph showing the electric field distribution within the filter 1 obtained with the height Hx of the cavities 12x being equal to the radius R3x of the cavities 12x. FIG. 5(c) is a graph showing the electric field distribution within the filter 1 obtained with the height Hx of the cavities 12x being greater than the radius R3x of the cavities 12x.

In a case where the height Hx of the cavities 12x is less than the radius R3x of the cavities 12x, the electric field leaking from the resonator 11x reaches the broad wall 122x of the cavity 12x, as shown in FIG. 5(a). This is thought to be a reason why, in a case where the height Hx of cavities 12x is less than the radius R3x of the cavities 12x, the center frequency of the passband strongly depends on (is sensitive toward) the height Hx of the cavities 12x.

In a case where the height Hx of the cavities 12x is greater than the radius R3x of the cavities 12x, the electric field leaking from the resonator 11x does not reach the broad wall 122x of the cavity 12x, as shown in FIG. 5(c). This is thought to be a reason why, in a case where the height Hx of cavities 12x is greater than the radius R3x of the cavities 12x, the center frequency of the passband does not strongly depend on (is not sensitive toward) the height Hx of the cavities 12x.

As described above, in the filter 1, the center frequency of the passband is determined in accordance with the heights Ha to He of the cavities 12a to 12e. Accordingly, when manufacturing the filter 1, by performing a process of adjusting the center frequency of the passband by changing the heights Ha to He of the cavities 12a to 12e, the filter 1 with the center frequency of the passband matching a desired frequency can be easily manufactured.

At this time, the height Hx of the cavities 12x is preferably less than the radius R3x of the cavities 12x. This is because, in this case, since the center frequency of the passband strongly depends on (is sensitive toward) the heights Ha to He of the cavities 12a to 12e, the heights Ha to He of the cavities 12a to 12e only need to be changed a small amount to shift the center frequency of the passband to a desired frequency.

As described above, in the filter 1, the center frequency of the passband is determined in accordance with the heights Ha to He of the cavities 12a to 12e. Accordingly, when manufacturing the filter 1, by performing a process of adjusting the center frequency of the passband by changing the heights Ha to He of the cavities 12a to 12e, the filter 1 with the center frequency of the passband matching a desired frequency can be easily manufactured.

Note that the adjustment of the center frequency of the passband in the filter 1 can also be achieved by changing the radii R3a to R3e of the cavities 12a to 12e as described in the second embodiment. In other words, the adjustment of the center frequency of the passband in the filter 1 can be achieved by changing the volume of the cavities 12a to 12e without being limited to whether the heights Ha to He of the cavities 12a to 12e are changed or the radii R3a to R3e of the cavities 12a to 12e are changed.

### Additional Cavity Function

The filter 1 can employ a configuration in which, instead of adjusting the center frequency of the passband by changing the heights Ha to He of the cavities 12a to 12e, the center frequency of the passband is adjusted by changing the size of the coupling windows 112a to 112e. In a case where the latter configuration is employed, it is possible to adjust the center frequency of the passband even if the cavities 12a to 12e are omitted from the filter 1.

However, omitting the cavities 12a to 12e may lead a problematic increase in loss caused by some of the electromagnetic waves guided through the post-wall waveguide 11 leaking from the coupling windows 112a to 112e. The cavities 12a to 12e have an additional function of suppressing such leakage of electromagnetic waves and thus reducing loss. In other words, in the filter 1, even if the configuration in which the center frequency of the passband is adjusted by changing the size of the coupling windows 112a to 112e is employed, the cavities 12a to 12e are necessary to suppress leakage of electromagnetic waves.

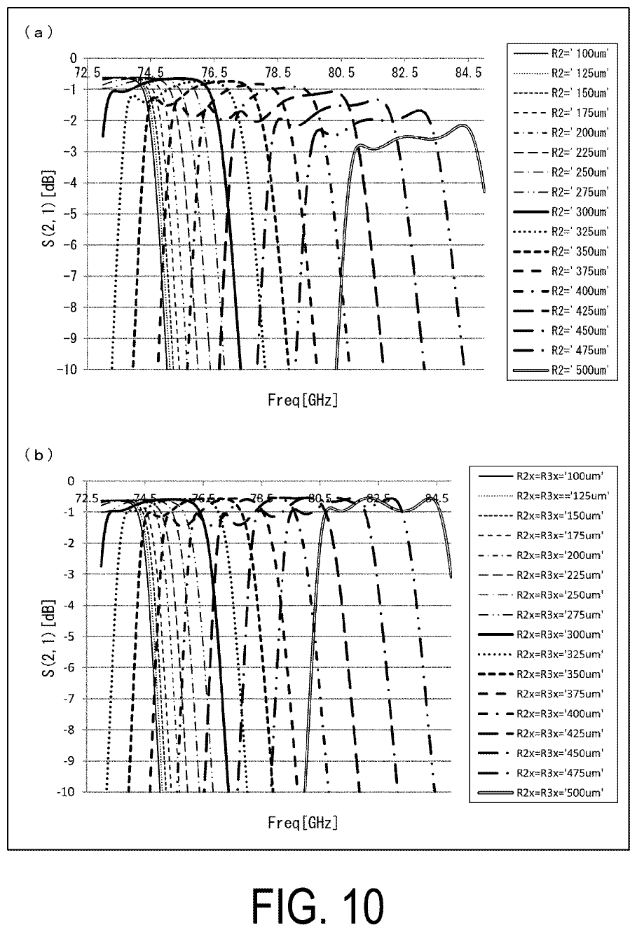

FIG. 10(a) is a graph showing the frequency dependence of the transmission coefficient S(2,1) of a filter obtained by omitting the cavities 12a to 12e from the filter 1 according to the first embodiment (hereinafter, referred to as a “filter according to the comparative example”). Here, the results are shown of a numerical simulation in which it is assumed that the material of the dielectric substrate 111 is set as quartz, the thickness of the dielectric substrate 111 is set as 520 μm, the radii R1a, R1e of the resonators 11a, 11e are set as 800 μm, the radii R1b to R1d of the resonators 11b to 11d are set as 840 μm, the dielectric material filling each of the cavities 12x is set as air, the height Hx of each of the cavities 12x is set as 600 μm, and the radius R3x of each of the cavities 12x is set to the same as the radius R2x of the coupling windows 112x.

FIG. 10(a) shows the transmission coefficient S(2,1) of the filter according to the comparative example obtained by uniformly changing the radius R2x of each of the coupling windows 112x from 100 μm to 400 μm in steps of 25 μm. According to FIG. 10(a), it can be seen that the greater the radius R2x of each of the coupling windows 112x, the more the center frequency of the passband shifts to the high frequency side. Also, according to FIG. 10(a), it can be seen that the greater the radius R2x of each of the coupling windows 112x, the more the overall transmission coefficient decreases due to an increase in loss.

FIG. 10(b) is a graph showing the frequency dependence of the transmission coefficient S(2,1) of the filter 1 according to the first embodiment (example). Here, the results are shown of a numerical simulation in which it is assumed that the material of the dielectric substrate 111 is set as quartz, the thickness of the dielectric substrate 111 is set as 520 μm, the radii R1a, R1e of the resonators 11a, 11e are set as 800 μm, the radii R1b to R1d of the resonators 11b to 11d are set as 840 μm, the dielectric material filling each of the cavities 12x is set as air, the height Hx of each of the cavities 12x is set as 600 μm, and the radius R3x of each of the cavities 12x is set to the same as the radius R2x of the coupling windows 112x.

FIG. 10(b) shows the transmission coefficient S(2,1) of the filter 1 obtained by uniformly changing the radius R2x of each of the coupling windows 112x from 100 μm to 400 μm in steps of 25 μm.

According to FIG. 10(b), it can be seen that the greater the radius R2x of each of the coupling windows 112x, the more the center frequency of the passband shifts to the high frequency side. Also, compared to FIG. 10(a), in FIG. 10(b), it can be seen that even if the radius R2x of each of the coupling windows 112x is increased, the overall decrease in the transmission coefficient due to an increase in loss is suppressed. In other words, it can be confirmed that the cavities 12a to 12e function to suppress loss.

### Second Embodiment

### Filter Configuration

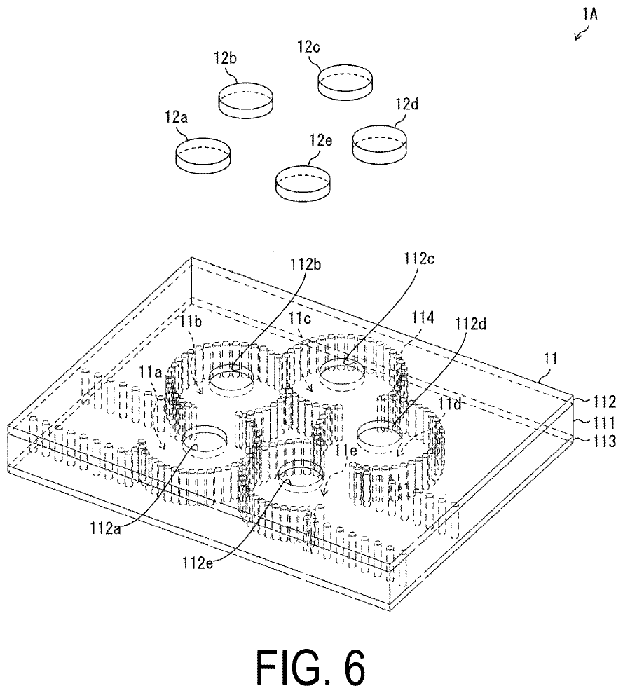

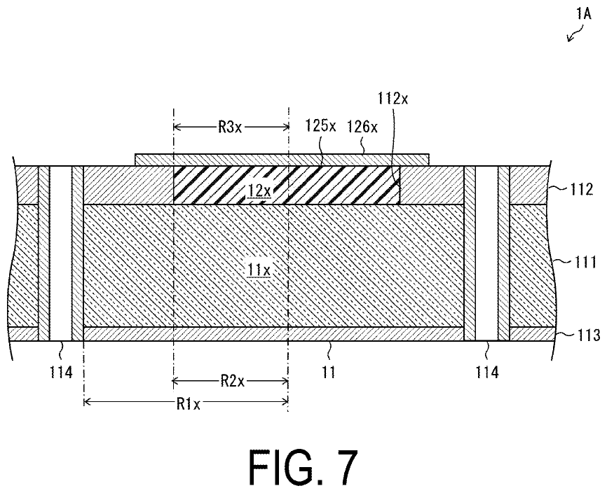

The configuration of a filter 1A according to the second embodiment of the present invention will be described with reference to FIGS. 6 and 7. FIG. 6 is an exploded perspective view of the filter 1A, and FIG. 7 is a partial cross-sectional view of the filter 1A.

The difference between the filter 1 according to the first embodiment and the filter 1A according to the present embodiment is the method of implementing the cavities 12a to 12e. In the filter 1 according to the first embodiment, each of the cavities 12x is implemented via the plate-like member 121, the broad wall 122x, and the narrow wall 123x. In the present embodiment, each of the cavities 12x is implemented via a dielectric layer 125x and a broad wall 126x.

The dielectric layer 125x is a layer-like member formed from a dielectric filling the coupling window 112x. In the present embodiment, a dielectric material with resin as a main component is used as the dielectric material forming the dielectric layer 125x. In the present embodiment, the dielectric layer 125x has the same shape as the coupling window 112x, that is, a cylindrical shape.

The broad wall 126x is a layer-like (or film-like) member formed from a conductor material. The broad wall 126x is formed sealing the coupling window 112x at the first main surface (the upper surface in FIGS. 6 and 7) of the dielectric layer 125x. In the present embodiment, copper is used as the conductor material forming the broad wall 126x.

The dielectric layer 125x is enclosed by a side wall of the coupling window 112x and the broad wall 126x. Thus, the dielectric layer 125x functions as the cavity 12x electrically coupled with the resonator 11x.

The filter 1A is configured in a similar manner to the filter 1, except for how the cavities 12a to 12e are implemented. Thus, a description other than the method of implementing the cavities 12a to 12e is omitted here.

Note that in the present embodiment, resin is used as the dielectric forming the dielectric layer 125x. However, the present invention is not limited to this. The dielectric forming the dielectric layer 125x may be a dielectric other than a resin.

Also, in the present embodiment, copper is used as the conductor material forming the broad wall 126x of each of the cavities 12x. However, the present invention is not limited to this. The conductor material forming the broad wall 126x of each of the cavities 12x may be aluminum or an alloy formed from a plurality of metal elements, for example.

### Cavity Function

The filter 1A includes the post-wall waveguide 11 functioning as the plurality of resonators 11a to 11 e that are electromagnetically coupled to each other. Accordingly, the filter 1A functions as a band-pass filter that selectively allows electromagnetic waves of a passband to pass. The cavities 12a to 12e are used to adjust the center frequency of this passband.

The results of an electromagnetic field simulation conducted to investigate the transmission characteristics and reflection characteristics of the filter 1A will be described below. Note that in an electromagnetic field simulation, it is assumed that the material of the dielectric substrate 111 is set as quartz, the thickness of the dielectric substrate 111 is set as 520 μm, the radii R1a, R1e of the resonators 11a, 11 e are set as 700 μm, the radii Rib, R1d of the resonators 11b, 11d are set as 725 μm, the radius R1c of the resonator 11c is set as 750 μm, the radius R2x of each of the coupling windows 112x is set to be the same as the radius R3x of the corresponding cavities 12x, the dielectric filling each of the cavities 12x is set as polyimide, and the height of each of the cavities 12x is set as 16 μm. Note that the height of each of the cavities 12x is the same as the thickness of the first broad wall 112.

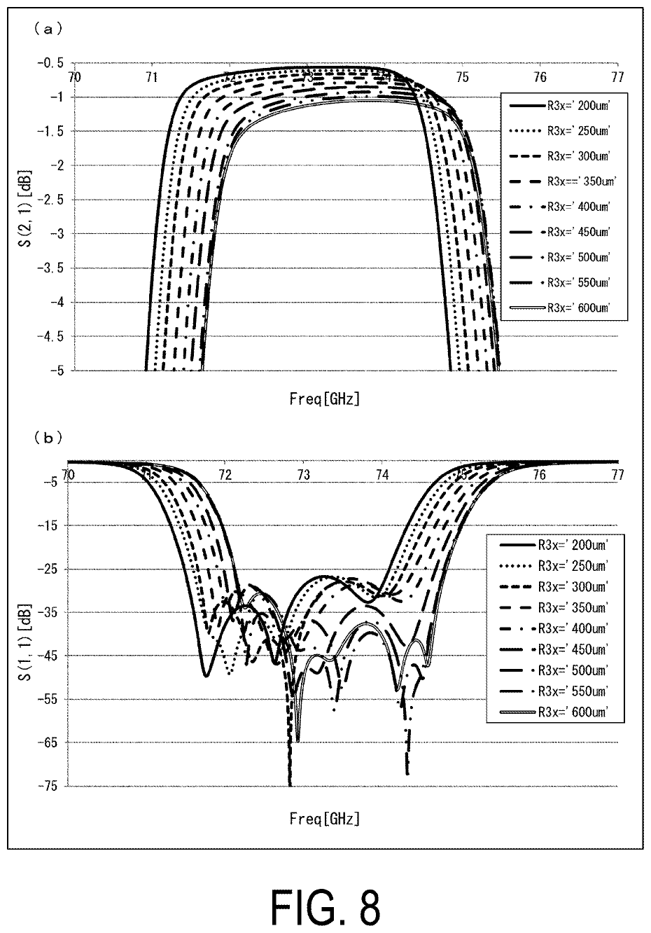

FIG. 8(a) is a graph showing the frequency characteristics of the transmission coefficient S(2,1) of the filter 1A obtained by uniformly changing the radius R3x of each of the cavities 12x from 200 μm to 600 μm in steps of 50 μm. The following can be seen from the graph shown in FIG. 8(a).
The greater the radius R3x of the cavities 12x, the more the center frequency of the passband shifts to the high frequency side.

FIG. 8(b) is a graph showing the frequency characteristics of the reflection coefficient S(1,1) of the filter 1A obtained by uniformly changing the radius R3x of each of the cavities 12x from 200 μm to 600 μm in steps of 50 μm. The following can be seen from the graph shown in FIG. 8(a).
The reflection coefficient S(1,1) in the passband is suppressed to at most −25 dB.

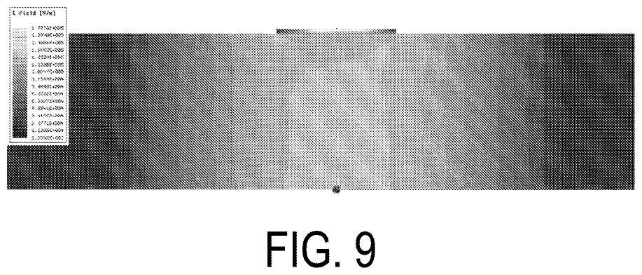

FIG. 9 is a graph showing the electric field distribution in each of the cavities 12x. Here, the radii R3a, R3e of the cavities 12a, 12e are 700 μm, the radii R3a, R3d of the cavities 12b, 12d are 725 μm, the radius R3c of the cavity 12c is 750 μm, and the intensity of the electric field is expressed by the depth of the color. According to the graph shown in FIG. 9, it can be seen that the electric field leaking from the resonator 11x reaches the side wall of the coupling window 112x. This is thought to be a reason why the center frequency of the passband depends on the radius R3x of each of the cavities 12x.

As described above, in the filter 1A, the center frequency of the passband is determined in accordance with the radii R3a to R3e of the cavities 12a to 12e. Accordingly, when manufacturing the filter 1A, by performing a process of adjusting the center frequency of the passband by changing the radii R3a to R3e of the cavities 12a to 12e, the filter 1A with the center frequency of the passband matching a desired frequency can be easily manufactured.

Note that the adjustment of the center frequency of the passband in the filter 1A can also be achieved by changing the heights Ha to He of the cavities 12a to 12e as described in the first embodiment. In other words, the adjustment of the center frequency of the passband in the filter 1 can be achieved by changing the volume of the cavities 12a to 12e without being limited to whether the radii R3a to R3e of the cavities 12a to 12e are changed or the heights Ha to He of the cavities 12a to 12e are changed.

### SUMMARY

A filter according to a first aspect of the present invention employs a configuration including:

a post-wall waveguide functioning as a resonator group including a plurality of resonators that are electromagnetically coupled to each other; and

at least one cavity stacked on the post-wall waveguide, wherein

the cavity is electromagnetically coupled with a resonator of the resonator group via a coupling window formed in a broad wall of the post-wall waveguide.

According to the configuration described above, by changing the volume of the cavity, the center frequency of the passband can be easily adjusted.

The filter according to a second aspect of the present invention employs a configuration wherein, in addition to the configuration of the filter according to the first aspect of the present invention, in a plan view of the broad wall, the coupling window is formed at a position overlapping a center of the resonator electromagnetically coupled with the cavity via the coupling window.

According to the configuration described above, the coupling efficiency of the electromagnetic coupling between the resonator and the cavity can be improved. Accordingly, the adjustment of the center frequency of the passband by changing the volume of the cavity can be performed more effectively.

The filter according to a third aspect of the present invention employs a configuration wherein, in addition to the configuration of the filter according to the first or second aspect of the present invention, the coupling window has a circular shape.

According to the configuration described above, the coupling efficiency of the electromagnetic coupling between the resonator and the cavity can be improved. Accordingly, the adjustment of the center frequency of the passband by changing the volume of the cavity can be performed more effectively.

The filter according to a fourth aspect of the present invention employs a configuration wherein, in addition to the configuration of the filter according to any one of the first to third aspects of the present invention, the resonator has a cylindrical shape with a height direction corresponding to a direction orthogonal to the broad wall.

According to the configuration described above, the coupling efficiency of the electromagnetic coupling between the resonator and the cavity can be improved. Accordingly, the adjustment of the center frequency of the passband by changing the volume of the cavity can be performed more effectively.

The filter according to a fifth aspect of the present invention employs a configuration wherein, in addition to the configuration of the filter according to any one of the first to fourth aspects of the present invention, the cavity has a cylindrical shape with a height direction corresponding to a direction orthogonal to the broad wall.

According to the configuration described above, the coupling efficiency of the electromagnetic coupling between the resonator and the cavity can be improved. Accordingly, the adjustment of the center frequency of the passband by changing the volume of the cavity can be performed more effectively.

The filter according to a sixth aspect of the present invention employs a configuration wherein, in addition to the configuration of the filter according to any one of the first to fifth aspects of the present invention, the cavity is implemented via a plate-like member including a recess portion, a broad wall formed on a bottom surface of the recess portion, and a narrow wall formed on a side surface of the recess portion.

According to the configuration described above, manufacturing of the filter can be performed more easily.

The filter according to a seventh aspect of the present invention employs a configuration wherein, in addition to the configuration of the filter according to any one of the first to fifth aspects of the present invention, the cavity is implemented via a dielectric layer including a dielectric filling the coupling window and a broad wall formed on a main surface on a side opposite a side facing the post-wall waveguide of the dielectric layer.

According to the configuration described above, by changing the volume of the cavity, the center frequency of the passband can be more easily adjusted.

A method of manufacturing, according to an eighth aspect of the present invention, the filter according to any one of the first to seventh aspects of the present invention employs a method including:

adjusting a center frequency of a passband by changing a volume of the cavity.

According to the method described above, a filter with the center frequency of the passband matching a desired frequency can be easily manufactured.

### APPENDIX

The present invention is not limited to each of the embodiments described above, and various modifications are possible within the scope of the claims, and embodiments obtained by appropriately combining techniques disclosed in different embodiments are also included within the technical scope of the present invention.

### REFERENCE SIGNS LIST

1, 1A Filter
11 Post-wall waveguide
111 Dielectric substrate
112 First broad wall
112a to 112e Coupling window
113 Second broad wall
114 Post-wall
11a to 11e Resonator
12a to 12e Cavity
121 Plate-like member
122a to 122e Narrow wall
123a to 123e Second broad wall
125a to 125e Dielectric substrate
126a to 126e Broad wall

1. A filter, comprising:
a post-wall waveguide functioning as a resonator group including a plurality of resonators that are electromagnetically coupled to each other; and
at least one cavity stacked on the post-wall waveguide, wherein
the cavity is electromagnetically coupled with a resonator of the resonator group via a coupling window formed in a broad wall of the post-wall waveguide.

2. The filter according to claim 1, wherein
in a plan view of the broad wall, the coupling window is formed at a position overlapping a center of the resonator electromagnetically coupled with the cavity via the coupling window.

3. The filter according to claim 1, wherein
the coupling window has a circular shape.

4. The filter according to claim 1, wherein
the resonator has a cylindrical shape with a height direction corresponding to a direction orthogonal to the broad wall.

5. The filter according to claim 1, wherein
the cavity has a cylindrical shape with a height direction corresponding to a direction orthogonal to the broad wall.

6. The filter according to claim 1, wherein
the cavity is implemented via a plate-like member including a recess portion, a broad wall formed on a bottom surface of the recess portion, and a narrow wall formed on a side surface of the recess portion.

7. The filter according to claim 1, wherein
the cavity is implemented via a dielectric layer including a dielectric filling the coupling window and a broad wall formed on a main surface on a side opposite a side facing the post-wall waveguide of the dielectric layer.

8. A method of manufacturing the filter according to claim 1, comprising:
adjusting a center frequency of a passband by changing a volume of the cavity.
